(19) United States
(12) Patent Application Publication
(10) Pub. No.: US 2002/0056382 A1
(43) Pub. Date: May 16, 2002

(54) Replaceable imaging device for creating images on printing forms

(76) Inventors: Bernhard Zintzen, Heidelberg (DE); Bernard Beier, Ladenburg (DE)

Correspondence Address: LERNER AND GREENBERG, P.A., PATENT ATTORNEYS AND ATTORNEYS AT LAW, Post Office Box 2480, Hollywood, FL, 33022-2480, US

(21) Appl. No.: 10/006,473

(22) Filed: Dec. 4, 2001

(30) Foreign Application Priority Data
Dec. 4, 2000 (DE) 100 60 321.1

(51) Int. Cl. B41F 5/00

(52) U.S. Cl. 101/216

(57) ABSTRACT

An imaging device for creating images on printing forms, with an imaging power source, includes a first subassembly including the imaging power source and having a mechanical interface detachably connected to at least one holding element; a printing unit with a holding element for the imaging device; a printing unit with the imaging device; an imagesetter having the imaging device; and a printing machine having the imaging device.

### BACKGROUND OF THE INVENTION

### FIELD OF THE INVENTION

The invention relates to an imaging device for creating images on printing forms, more particularly, with an imaging power source.

Typical imaging devices, such as are provided, for example, in printing machines, on printing units, on printing-form imagesetters or the like, include at least one imaging power source, for example, a light source, a source of particulate radiation or the like, in particular, a laser light source, which can emit visible and/or invisible light, with which reproduction optics, light guiding elements, beam shaping elements or the like are frequently associated. Imaging devices with a light source have become known heretofore, wherein at least the reproduction optics are permanently installed and adjusted, in comparison with the carrier of the printing form, for example, the printing-form cylinder. Typically, the light source, in particular a laser light source, is permanently connected and adjusted to the printing machine, to the printing unit, which includes the printing-form cylinder whereon the printing form to be imaged can be held, to the printing-form imagesetter or the like. In this regard, the light source can also be located at a given distance from the imaging optics and the printing form to be exposed, the light being deflected towards the reproduction optics, i.e., towards the printing form to be exposed, by light guiding elements or the like.

In U.S. Pat. No. 4,395,946, a rotary printing machine is disclosed which includes a laser-beam imaging device for preparing a rotating printing element while the latter is located in the printing machine. The laser-beam imaging device includes a YAG laser, which is placed in an optical resonator, a beam widening device, a modulator with a beam trap and a mirror. In addition, a helium/neon laser is aligned with the YAG laser. This part of the laser-beam imaging device is fixed in position at the side of the printing machine.

In the published European Patent Document EP 0 949 071 A1, an additional device for a printing unit is disclosed which, through the intermediary of a pivoting mechanism, is fixed to the printing machine. An important application is for the additional device to be an imaging device which, in a working position, is set against the plate cylinder. Such imaging devices may be a laser exposure unit for the plate cylinders.

A disadvantage of such imaging devices is that a laser imaging device is permanently associated with a printing unit or a printing element. In order to overcome this limitation, imaging devices have been proposed by which, proceeding from one imaging device, imaging of a several printing forms is permitted.

In the published German Patent Document DE 195 23 378 A1, a printing machine is described wherein imaging of two form cylinders can be performed by a single imaging system. In one exemplary embodiment, an imaging system is disclosed which can be associated selectively with both form cylinders, for example, by a pivoting device, or by suitably deflecting beams of the imaging system so that imaging of both form cylinders can take place.

In the published German Patent Document DE 197 10 520 C1, a printing machine is disclosed which has a multiplicity of printing-form cylinders and by which one imaging device applies images to at least two printing-form cylinders. The imaging device is locally fixed. Laser pulses are deflected to the form cylinders by suitable light deflectors, for example, optical waveguides.

A disadvantage of such imaging devices is that a failure of the imaging device causes printing forms in a major part of the machine, for example, in one or more printing units, or even in the entire printing machine, no longer to be able to be imaged, so that, if necessary or desirable, machine production may be restricted, or the machine may even no longer be used for production.

In heretofore known imaging devices, it is generally disadvantageous, that the imaging device, from a construction viewpoint, be firmly, i.e., permanently, connected to the printing machine, to the printing unit, to the printing-form imagesetter or the like. In other words, if the connecting elements are released, a comprehensive readjustment of the imaging device is required for the purpose of imaging printing forms. A simple and quick change is not possible.

### SUMMARY OF THE INVENTION

It is therefore an object of the invention of the instant application to provide a replaceable imaging device for creating images on printing forms, wherein the functional readiness of the printing machine, the printing unit or the printing-form imagesetter is increased.

With the foregoing and other objects in view, there is provided, in accordance with one aspect of the invention, an imaging device for creating images on printing forms, with an imaging power source, comprising a first subassembly including the imaging power source and having a mechanical interface detachably connected to at least one holding element.

In accordance with another feature of the invention, the holding element is a second subassembly belonging to the imaging device.

In accordance with a further feature of the invention, the first subassembly includes a baseplate, and the holding element includes a counterplate, the baseplate being detachably connectable to the counterplate in at least one fixed position relative to one another.

In accordance with an added feature of the invention, the baseplate has at least one feature selected from the group thereof consisting of at least one specific geometric shaping corresponding, in at least one unique association, to at least one inverted specific geometric shaping in the counterplate, and a plurality of geometric elements corresponding, in unique associations, to a plurality of inverted geometric elements in the counterplate.

In accordance with an additional feature of the invention, at least one of the at least one specific geometric shaping and the plurality of geometric elements, and at least one of the inverted specific geometric shaping and the plurality of inverted geometric elements constitute at least one of a stop and a recess, respectively.

In accordance with yet another feature of the invention, at least one of the specific geometric shapings and the plurality of geometric elements, and at least one of the specific inverted shapings and the plurality of inverted specific geometric elements constitute combined stops and recesses.

In accordance with yet a further feature of the invention, the first subassembly and the holding element have a closing device comprising at least one closing part and at least one counterpiece for fixing the first subassembly to the holding element.

In accordance with yet an added feature of the invention, the imaging device includes a closing part which, at least in one position of the first subassembly relative to the holding element, is uniquely associated with a counterpiece, one of the closing part and the associated counterpiece being disposed on the first subassembly, and the other of the closing part and the associated counterpiece being disposed on the holding element.

In accordance with yet an additional feature of the invention, the imaging device includes an actuator for aligning, at least to some extent, the first subassembly relative to the holding element.

In accordance with still another feature of the invention, the first subassembly and the holding element include at least one coupling device having at least one line plug and at least one matching line plug for quick connection of at least one line.

In accordance with still a further feature of the invention, the line plug has a matching line plug associated uniquely therewith in at least one position of the first subassembly relative to the holding element, one of the line plug and the associated matching line plug being disposed in the first subassembly, and the other of the line plug and the associated matching line plug being disposed in the holding element.

In accordance with still an added feature of the invention, the coupling device for quick connection of at least one line has at least one line for exchanging at least one of a group of values consisting of values related to compressed air, liquids, gases, electricity, data and light.

In accordance with still an additional feature of the invention, the holding element includes a carriage part movable along a guide path.

In accordance with another feature of the invention, the first subassembly includes a carriage part movable along a guide path.

In accordance with a further aspect of the invention, there is provided a printing unit comprising at least one holding element for an imaging device for creating images on printing forms, with an imaging power source, having a first subassembly including the imaging power source and having a mechanical interface detachably connected to the at least one holding element.

In accordance with an added aspect of the invention, there is provided a printing unit having at least one imaging device for creating images on printing forms, with an imaging power source, comprising a first subassembly including the imaging power source and having a mechanical interface detachably connected to at least one holding element.

In accordance with an additional aspect of the invention, there is provided a printing-form imagesetter, having at least one imaging device for creating images on printing forms, with an imaging power source, comprising a first subassembly including the imaging power source and having a mechanical interface detachably connected to at least one holding element.

In accordance with yet another aspect of the invention, there is provided a printing machine having a printing unit comprising at least one holding element for an imaging device for creating images on printing forms, with an imaging power source, having a first subassembly including the imaging power source and having a mechanical interface detachably connected to the at least one holding element.

In accordance with yet a further aspect of the invention, there is provided a printing machine having a printing unit with at least one imaging device for creating images on printing forms, with an imaging power source, comprising a first subassembly including the imaging power source and having a mechanical interface detachably connected to at least one holding element.

In accordance with a concomitant feature of the invention, the at least one holding element serves for holding the imaging device.

Thus, the imaging device according to the invention for creating images on printing forms, having an imaging power source, is distinguished by the fact that it has a first subassembly comprising the imaging power source and having a mechanical interface, which can be connected detachably to at least one holding element belonging to the imaging device. The imaging power source is preferably a light source, in particular a laser light source such as a semiconductor or diode laser. Furthermore, imaging optics for beam shaping, deflection and/or focusing can be provided, some of which can be associated with the first subassembly and some of which can be associated with the holding element. As an alternative to a light source, sources of particulate radiation, for example an electron radiation source, a discharge source or the like, can be used as the imaging power source. The mechanical interface and the holding element form a standardized connection, which is preferably of identical construction on various printing machines, printing units or printing-form imagesetters. The holding element may be a second subassembly belonging to the imaging device according to the invention. The first subassembly advantageously comprises a baseplate, and the holding element comprises a matching or counterplate, it being possible for the baseplate and the counterplate to be detachably connected to one another in at least one fixed position. The mechanical interface, in particular, the plates, can be substantially planar or can have a radius of curvature depending upon the location on the plate. The baseplate has at least one specific geometric shaping and/or a number of generally different geometric elements, which correspond to at least an inverted specific geometric shaping and/or a number of inverted geometric elements in the counterplate. In this regard, by an inverted geometric shaping or an inverted geometric element, it is understood to mean a shape complementary to a specific geometric form or a geometric element complementary to a specific geometric element. A shape and the complement thereof or an element and the complement thereof can be brought into contact and connection with one another with an accurate in-register fit.

By the imaging device according to the invention, a unit is provided which is independent of the printing unit, of the printing machine or of the printing-form imagesetter and which can be used on various printing units, printing machines or printing-form imagesetters, even as a replacement. The device according to the invention offers a series of advantages. As a result of the construction as an independent unit, the utilization of the imaging unit is increased if it is used on various printing units, printing machines or printing-form imagesetters, and the investment costs can be reduced, because fewer imaging units than printing units, printing machines or printing-form imagesetters are needed. In other words, the first subassembly, including the imaging power source, of the imaging device can be interchanged between the printing units within a printing machine if at least one holding element belonging to the imaging device is provided and fixed to each of the relevant printing units.

Because the imaging devices according to the invention can be connected variably to a specific machine, whether it is a printing machine, a printing unit, a printing-form imagesetter or the like, several printing plates can be imaged successively by the imaging device. If a printing unit or a printing machine is used for production, an image can be set on a further printing unit or a further printing machine while the printing process of that printing unit or that printing machine is being carried out. During this time, the imaging device can be used beneficially. In the event of a failure of the imaging device, tiresome repairs, entailed by having to fix and adjust a replacement imaging device in the printing machine, the printing unit, the printing-form imagesetter or the like, are rendered superfluous. Work of this type is reduced, so that an unacceptably long failure time can be reduced by replacing an imaging device according to the invention for an imaging device of the prior art.

The first subassembly of the imaging device can, therefore, be removed from a printing unit, and detachably connected and adjusted to a holding element of the imaging device on at least one further printing unit. The detachable connection is, in this regard, constructed so that it permits high precision, in other words, so that the first subassembly is almost immediately located in the correct position by appropriate stops and/or interlocks when being connected to the holding element by appropriate arrangements and/or shapes. Further connecting elements, such as the power supply, data transmission, cooling water, air supply and the like, are likewise provided in a simply detachable form.

In an advantageous development of the invention, the first subassembly of the imaging device on the holding element of the imaging device can also be aligned automatically with high precision. For example, by using actuators, an alignment for the accurate positional fixing or positional adjustment can be performed. A combination of a mechanical and a self-aligning, automatic coupling is particularly advantageous.

Furthermore, holding elements of the imaging device can be provided on various printing units of at least two different printing machines, so that the first subassembly, which includes the imaging power source, the imaging device can be interchanged between the at least two printing machines or printing-form imagesetters. The at least two different printing machines can in this case belong to the same series or a different series. Furthermore, it is advantageously possible to provide a number of different first subassemblies of the imaging device, for example, having different imaging power sources, a different number of imaging power sources or the like, which can be detachably connected to at least one holding element of the imaging device. By using the device according to the invention, the rapid use or the rapid changing of a plurality of various imaging power sources is therefore possible in a printing unit, a printing machine or a printing-form imagesetter. In particular, the simple interchangeability or the simple changing due to the detachable connection of the first subassembly of the imaging device, including the imaging power source, to at least one holding element of the imaging device permits simple operation by the customer. A complicated adjustment operation is avoided.

In an alternative embodiment of the invention, at least one holding element of the imaging device can be provided at a desired location in the printing machine or the printing-form imagesetter, by which appropriate light guiding elements can be provided for supplying the light to the desired location at which the printing form to be imaged may be located. In addition, in such an embodiment, a rapid replacement of first subassemblies of the imaging device, which include the imaging power source, can be performed.

As those skilled in the art will readily see, one of the important functions of the aforedescribed holding element, in particular, of the aforedescribed second subassembly of the imaging device, is the determinations of a well-defined interface geometry or interface topography. Configuring the holding part of the printing machine, the printing unit, the printing-form imagesetter or the like by specific geometric shaping and/or a number of generally different geometric elements for directly holding the first subassembly according to the invention is of equal value for this purpose.

Other features which are considered as characteristic for the invention are set forth in the appended claims.

Although the invention is illustrated and described herein as embodied in a replaceable imaging device for creating images on printing plates, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings, wherein:

### BRIEF DESCRIPTION OF THE DRAWINGS

FIGS. 1a and 1b are diagrammatic side elevational assembled and disassembled views, respectively, of two subassemblies of the imaging device according to the invention;

FIGS. 2a and 2b are a diagrammatic bottom plan view and fragmentary side elevational view, respectively, of a first subassembly of the imaging device;

FIGS. 2c and 2d are a diagrammatic fragmentary side elevational view and a top plan view, respectively, of a second subassembly of the imaging device;

FIG. 3 is a fragmentary diagrammatic side elevational view of a printing machine showing two printing units with an imaging device according to the invention; and

FIG. 4 is a front elevational view of the righthand printing unit of FIG. 2 as viewed from between the two printing units of FIG. 2, and showing the righthand printing unit with an imaging device according to the invention.

### DESCRIPTION OF THE PREFERRED EMBODIMENTS

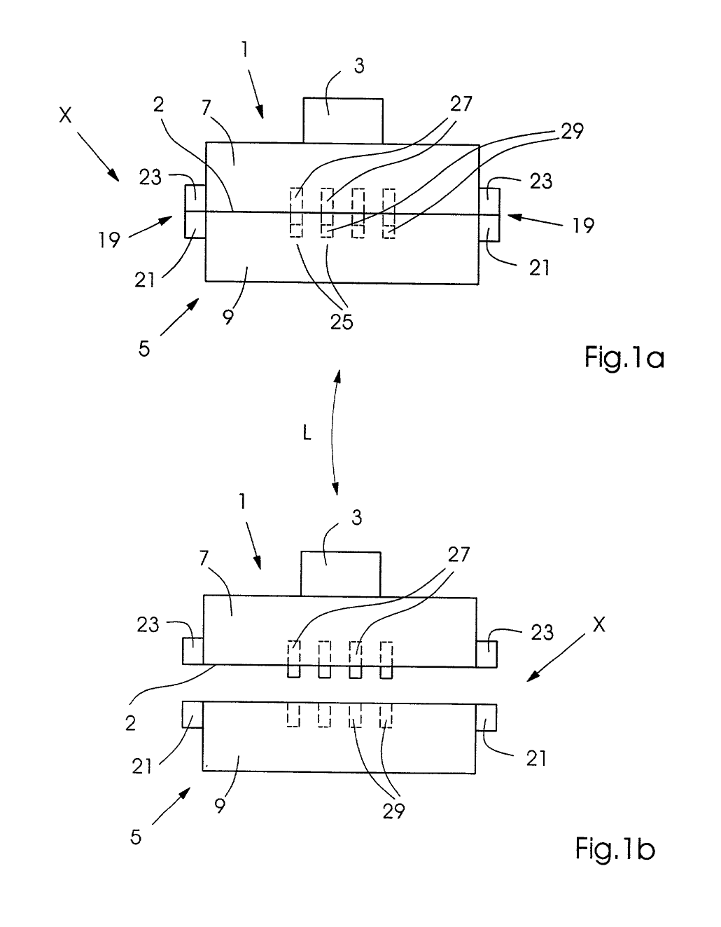

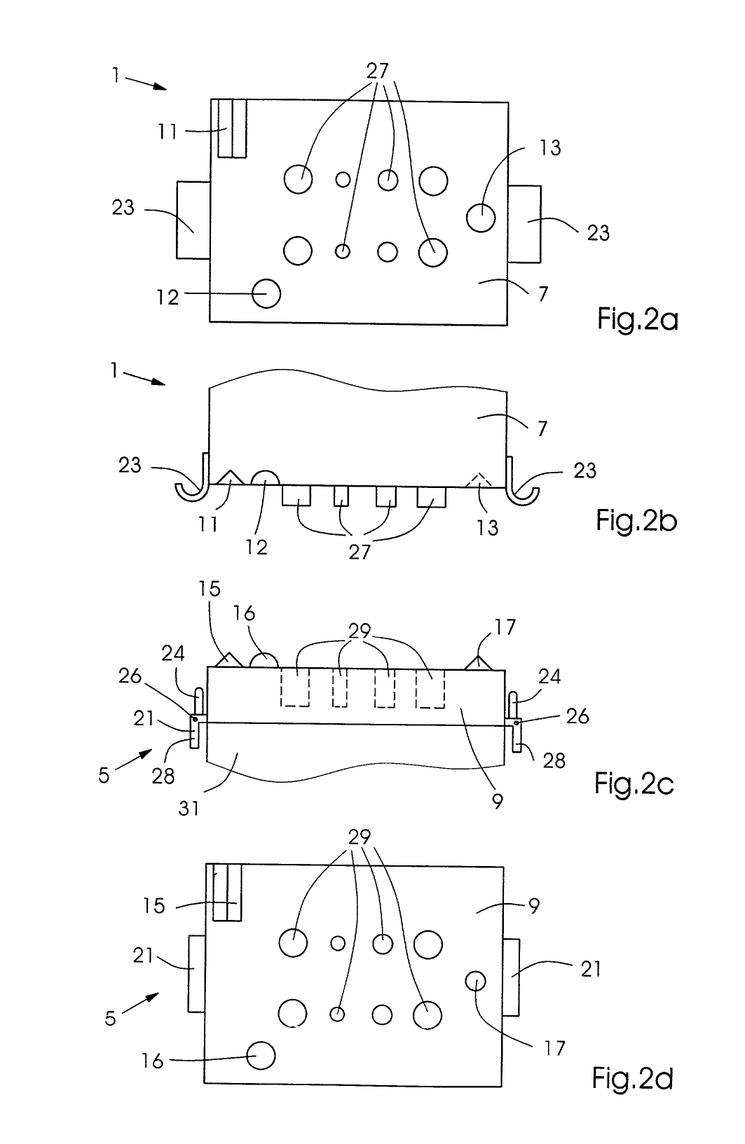

Referring now to the drawings and, first, particularly to FIG. 1a thereof, there is shown therein diagrammatically, in a side elevational view, a preferred embodiment of an imaging device X according to the invention. In FIG. 1a, a first subassembly 1 of the imaging device X according to the invention, having a geometric interface 2, and including an imaging power source 3, preferably a light source such as a laser light source, which can emit visible and/or invisible light, is detachably connected to a holding element 5 belonging to the imaging device X. In this regard, the first subassembly 1 has a baseplate 7 and the holding element 5 has a matching or counterplate 9, the baseplate 7 and the matching plate 9 being detachably connectable to one another in a fixed position. The diagrammatically illustrated embodiment of FIG. 1a includes closing devices 19, of which each has a closing part 21 and a matching or counterpiece 23. In the diagrammatically illustrated embodiment, two closing devices 19 are provided, by way of example, the closing parts 21, respectively, being fixed to the holding element 5, while the matching pieces 23 are fixed to the first subassembly 1. It is also conceivable, however, that the closing devices 19 have at least one closing part 21 fixed to the first subassembly 1 and at least one matching piece 23 is fixed to the holding element 5. The two different embodiments can also be provided jointly on an imaging device X according to the invention. Furthermore, coupling devices 25, which are optionally four in number in the diagrammatically illustrated embodiment of FIG. 2a, are provided on the imaging device X according to the invention, and have line plugs 27 and matching line plugs or sockets 29 for the rapid connection of lines. In the diagrammatically illustrated embodiment of the imaging device X according to the invention, the line plugs 27 are provided on the baseplate 7 of the first subassembly 1, and the matching line plugs or sockets 29 are provided on the matching plate 9 of the holding element 5. It is likewise conceivable for at least one line plug 27 to be provided on the matching plate 9 of the holding element 5, and the matching line plug or socket 29 associated therewith to be provided on the baseplate 7 of the first subassembly 1. A line plug 27, for example, a male plug, is associated with a matching line plug or socket 29, for example, a female line plug, uniquely in at least one position of the first subassembly 1 and the holding element 5, the line plug 27 being provided in the one position in either the first subassembly 1 or the holding element 5, and the associated matching plug 29 being provided in the other, either the holding element 5 or the first subassembly 1. The coupling device 25 has at least one line for interchanging at least one substance from a set thereof, including compressed air, liquids, gases or electricity, and/or of data and/or of light. A coupling technique of this type is marketed, for example, by the STÄUBLI company.

In FIG. 1b, the assembled imaging device X according to the invention is shown diagrammatically separated by a detachment operation represented by a double-headed curved arrow L into the first subassembly 1 and the holding element 5, which are independent of one another. The imaging device X is thus a unit which, by the detachment and fixing operation, respectively, which is represented by the double-headed arrow L, can be changed or converted from a detachably fixed state of the first subassembly 1 and the holding element 5 in relation to one another into a detached state, wherein the first subassembly 1 and the holding element 5 are independent of one another, and the reverse. FIG. 1b shows the first subassembly 1 of the imaging device X according to the invention, which includes the imaging power source 3, with a baseplate 7, matching or opposing pieces 23 and line plugs 27 independent of the holding element 5 with the matching plate 9, closing parts 21 and matching line plugs or sockets 29.

FIGS. 2a and 2b are plan and side elevational views, respectively, of a preferred embodiment of the first subassembly 1 and of the holding element 5 of the imaging unit according to the invention. In FIG. 2a, the baseplate 7 is shown in plan view and, in an advantageous embodiment, bears line plugs 27, optionally eight of them in this embodiment. Furthermore, geometric shapes 11 and 12 and a geometric element 13 are provided on the baseplate 7. In the diagrammatically illustrated advantageous embodiment, the geometric shapes 11 and 12 are a prismatic recess 11 and a recess 12 shaped like a segment of a sphere, respectively. The geometric element 13, shown by way of example, is a special contact surface, for example likewise a contact surface 13 cut out in a conical shape.

In FIG. 2b, the baseplate 7 of the first subassembly 1 is shown in a side elevational view. The baseplate 7 accommodates matching pieces 23, in this embodiment, two thereof, respectively, disposed on the sides thereof, belonging to the closing device 19. For example, they are hooks in this embodiment. In this diagrammatic side elevational view of FIG. 2b, it is possible to see the line plugs 27, and the geometric shapes, i.e., the prismatic recess 11 and the recess 12 shaped like a segment of a sphere, and the geometric element 13 representing a contact surface 13 that has been cut out in a conical shape are also shown.

In FIG. 2c, the holding element 5 of the image-setting device X according to the invention is shown in a side elevational view. The matching plate 9 which, in the embodiment shown in FIG. 2c, is fixed on a carriage part 31 that is not shown in detail, is provided with matching line plugs 29, inverted geometric shapes 15 and 16, namely, in this embodiment, a prismatic elevation 15 as a stop and an elevation 16 shaped like a segment of a sphere as a stop, and an inverted geometric element 17, here a contact surface 17 elevated in a conical shape as a contact surface. Also fixed to the matching plate 9 are closing parts 21, here respectively fixed to the side of the matching plate 9, which are provided in order to connect with the matching pieces 23 of the first subassembly 1 for the purpose of forming the detachable connection. For example, the closing parts are constructed so that they have movable but fixable clips which, in the fixed state, can close around the matching pieces 23, i.e., the hooks 23 in the diagrammatically shown embodiment. A fixing lever can be moved about a pivot 26 and can be brought into at least two positions, the clips 24 closing firmly around the hook 23 or releasing it, depending upon the position. Other forms of quick-acting closures are also conceivable and provided in alternative embodiments of the imaging device X according to the invention.

In FIG. 2d, the matching plate 9 is shown diagrammatically in a plan view. The matching plate 9 has matching plugs 29, eight in this embodiment, and the inverted geometric shapes 15 and 16 which are provided provided are a prismatic elevation 15 and an elevation 16 shaped like a segment of a sphere, and the inverted geometric element 17 that is provided is an elevated contact surface 17 of conical shape.

In advantageous developments of the imaging device X according to the invention, the baseplate 7 has specific, generally different geometric shapes 11 and 12 and/or a number of generally different geometric elements 13. In at least one unique association, these shapes 11 and 12 and/or elements 13 correspond to inverted or complementary geometric shapes 15 and 16, respectively, and inverted or complementary geometric elements 17 in the matching plate 9. In this regard, it is unimportant whether there are stops and/or recesses in the baseplate 7, and recesses and/or stops which, respectively, are of inverted or complementary construction, in the matching plate 9. In advantageous developments of the invention, combined stops and recesses are also provided as specific geometric shapes 11 and 12 and/or as geometric elements 13 and, respectively, as specific inverted geometric shapes 15 and 16 and/or as inverted geometric elements 17.

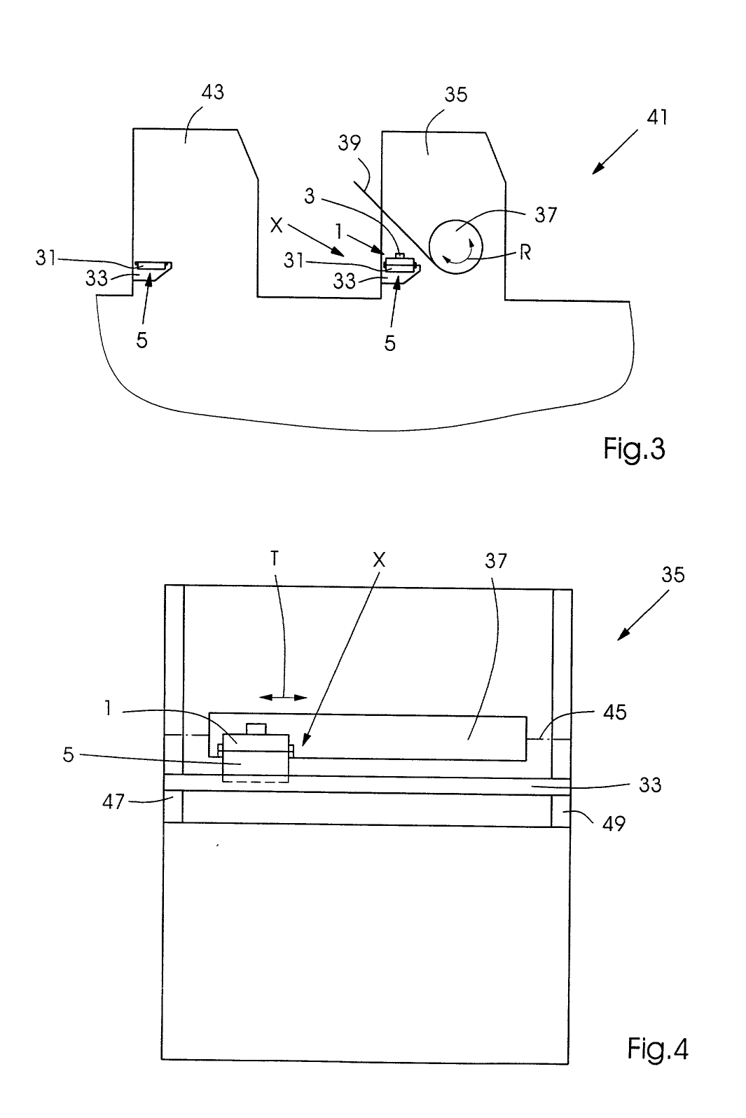

FIG. 3 shows a printing unit 35 having an imaging device X according to the invention with a first subassembly 1, which includes the imaging power source 3, and a holding element 5, which includes a carriage part 31. The carriage part 31 is accommodated in a guide 33, relative to which it can be moved. The carriage part 31 can be moved along the path of a guide 33. The guide 33 is, in turn, accommodated in the printing unit 35. The printing unit 35 has a printing-form cylinder 37, which can perform a rotational movement represented by the double-headed curved arrow R. A printing form 39 can be brought into formlocking contact on the printing-form cylinder 37, so that the imaging device X according to the invention can create an image on the printing form 39 in the printing unit 35. In this regard, it is noted that a formlocking connection is one which connects two elements together due to the shape of the elements themselves, as opposed to a force-locking connection, which locks the elements together by force external to the elements. A printing machine 41 can include a further printing unit 43 upline or downline from the printing unit 35, which has a holding element 5 with a carriage part 31 that is movably accommodated in a guide 33. The detachable first subassembly 1, which includes an imaging power source 3, can then be moved from one printing unit to a further printing unit 43 or interchanged between the printing units 35 and 43.

In an alternative embodiment of the imaging device X according to the invention, provision can also be made for the first subassembly 1 to include a carriage part 31 that can be moved along the path of a guide 33. In this case, provision is advantageously made for the carriage part 31 and the baseplate 7 to be constructed so that they are permanently connected. Furthermore, in a further alternative embodiment of the imaging device X according to the invention, provision can also be made for the first subassembly 1 to include, in addition to a carriage part 31, a guide 33 defining a path along which the carriage part 31 can be moved.

In FIG. 4, the printing unit 35 having an imaging device X according to the invention is shown in a front view taken from between the printing units 35 and 43 in FIG. 3. Shown in FIG. 4 is the first subassembly 1, which has the imaging power source 3, and the associated holding element 5, which has a carriage part 31. The carriage part 31 can be moved in the direction represented by the double-headed horizontal arrow T with respect to the guide 33 holding the carriage part 31. The guide 33 is fixed in a first side wall 47 and a second side wall 49 of the printing unit 35. A printing-form cylinder 37 is held in the first side wall 47 and the second side wall 49. The printing-form cylinder 37 is rotatable about the axis 45. By using the imaging device X according to the invention, a printing form resting on the printing-form cylinder 37 can be exposed by utilizing the movements in the translational direction T and in the rotational direction R about the axis 45 of the printing-form cylinder 37.

An imaging device X of this type according to the invention can also be provided and advantageously employed on a printing-form imagesetter for creating images on printing forms.

We claim:

1. An imaging device for creating images on printing forms, with an imaging power source, comprising a first subassembly including the imaging power source and having a mechanical interface detachably connected to at least one holding element.

2. The imaging device according to claim 1, wherein said holding element is a second subassembly belonging to the imaging device.

3. The imaging device according to claim 1, wherein said first subassembly includes a baseplate, and said holding element includes a counter-plate, said baseplate being detachably connectable to said counter-plate in at least one fixed position relative to one another.

4. The imaging device according to claim 1, wherein said baseplate has at least one feature selected from the group thereof consisting of at least one specific geometric shaping corresponding, in at least one unique association, to at least one inverted specific geometric shaping in said counter-plate, and a plurality of geometric elements corresponding, in unique associations, to a plurality of inverted geometric elements in said counterplate.

5. The imaging device according to claim 4, wherein at least one of said at least one specific geometric shaping and said plurality of geometric elements, and at least one of said inverted specific geometric shaping and said plurality of inverted geometric elements constitute at least one of a stop and a recess, respectively.

6. The imaging device according to claim 4, wherein at least one of said specific geometric shapings and said plurality of geometric elements, and at least one of said specific inverted shapings and said plurality of inverted specific geometric elements constitute combined stops and recesses.

7. The imaging device according to claim 1, wherein said first subassembly and said holding element have a closing device comprising at least one closing part and at least one counterpiece for fixing said first subassembly to said holding element.

8. The imaging device according to claim 7, including a closing part, at least in one position of said first subassembly relative to said holding element, being uniquely associated with a counterpiece, one of said closing part and said associated counterpiece being disposed on said first subassembly, and the other of said closing part and said associated counterpiece being disposed on said holding element.

9. The imaging device according to claim 1, including an actuator for aligning, at least to some extent, said first subassembly relative to said holding element.

10. The imaging device according to claim 1, wherein said first subassembly and said holding element include at least one coupling device having at least one line plug and at least one matching line plug for quick connection of at least one line.

11. The imaging device according to claim 10, wherein said line plug has a matching line plug associated uniquely therewith in at least one position of said first subassembly relative to said holding element, one of said line plug and said associated matching line plug being disposed in said first subassembly, and the other of said line plug and said associated matching line plug being disposed in said holding element.

12. The imaging device according to claim 10, wherein said coupling device for quick connection of at least one line has at least one line for exchanging at least one of a group of values consisting of values related to compressed air, liquids, gases, electricity, data and light.

13. The imaging device according to claim 1, wherein said holding element includes a carriage part movable along a guide path.

14. The imaging device according to claim 1, wherein said first subassembly includes a carriage part movable along a guide path.

15. A printing unit comprising at least one holding element for an imaging device for creating images on printing forms, with an imaging power source, having a first subassembly including the imaging power source and having a mechanical interface detachably connected to said at least one holding element.

16. A printing unit having at least one imaging device for creating images on printing forms, with an imaging power source, comprising a first subassembly including the imaging power source and having a mechanical interface detachably connected to at least one holding element.

17. A printing-form imagesetter, having at least one imaging device for creating images on printing forms, with an imaging power source, comprising a first subassembly including the imaging power source and having a mechanical interface detachably connected to at least one holding element.

18. A printing machine having a printing unit comprising at least one holding element for an imaging device for creating images on printing forms, with an imaging power source, having a first subassembly including the imaging power source and having a mechanical interface detachably connected to said at least one holding element.

19. A printing machine having a printing unit with at least one imaging device for creating images on printing forms, with an imaging power source, comprising a first subassembly including the imaging power source and having a mechanical interface detachably connected to at least one holding element.

20. A printing machine according to claim 18, wherein said at least one holding element serves for holding said imaging device.
